(19) United States
(12) Patent Application Publication
(10) Pub. No.: US 2013/0226317 A1
(43) Pub. Date: Aug. 29, 2013

(54) Apparatus That Analyses Attributes Of Diverse Machine Types And Technically Upgrades Performance By Applying Operational Intelligence And The Process Therefor

(71) Applicants: Athulan Vijayaraghavan, East Tambaram (IN); William Sobel, Berkeley, CA (US)

(72) Inventors: Athulan Vijayaraghavan, East Tambaram (IN); William Sobel, Berkeley, CA (US)

(73) Assignee: MANUFACTURING SYSTEM INSIGHTS (INDIA) PVT. LTD., Chennai (IN)

(21) Appl. No.: 13/821,702

(22) PCT Filed: Sep. 8, 2011
(86) PCT No.: PCT/IN2011/000616

§ 371 Date: Mar. 8, 2013

(30) Foreign Application Priority Data
Sep. 13, 2010 (IN) 2655/CHE/2010

(51) Int. Cl. G05B 13/02

(52) U.S. Cl. CPC G05B 13/02
USPC 700/28

(57) ABSTRACT

In a computerised system of control, management and optimisation for machine tools, operational data thereof is compared/matched with historical data in realtime. Historical and contemporary operation data of the same and/or other machines, including machines of other species is harvested and housed in a central data warehouse that is continuously updated. Operation data, and patterns thereof, of non-invasive attributes of the target machine(s) are compared/matched with the warehoused data by multi-variate analysis, thresholding and symbolic and non-symbolic pattern matching to generate control inputs and metrics for performance evaluation, performance upgrade such as of legacy machines and for status evaluation with regard to health(maintenance), risk/safety and environmental impacts thereof. Preferably, the power attributes of voltage, amperage, wattage and power factor together with compressed air and coolant flow rates are monitored. Methods of operating data processing/transformation are disclosed. The system can be applied to other machines and processes.

### FIELD OF THE INVENTION

This invention relates to a system for the control, management and optimisation of industrial machines and processes. More particularly, it relates to a method, system and devices for the control, management and optimisation of set(s) of one or more industrial machines and processes, said method, system and devices providing signal outputs for displaying/broadcasting instructions/programme for maintenance according to preventive, predictive or other system of maintenance; control input(s) for augmenting machine(s) productivity; control input(s) for improvement of the operational efficiency of said machine(s); control input(s) for optimisation of the performance of said machine(s); signal output(s) for activation of a system of indicators/annunciators for indicating the environmental impact(s) thereof; and signal output(s) for activation of a system of safety alarms/annuciators/indicators and others.

### BACKGROUND OF THE INVENTION AND PRIOR ART

With the increase in complexity of manufacturing systems and processes, there is a growing need to bring together advances from different realms of manufacturing technology. Products are getting more complex and tolerances tighter. This calls for looking at multiple aspects of the manufacturing process to achieve the required levels of quality, and the better response times required in the control and management of manufacturing processes and in the development process from design to product. Such stringent demands of processing machine users calls for a holistic approach to process planning, process improvement, process control, process optimisation and process maintenance, safety and environmental considerations.

This invention provides such a holistic solution to the problems of control, productivity, efficiency, optimisation, maintenance, safety and environmental concerns that is applicable in general to all industry sectors but is particularly focused on metal processing industries employing machine tools. This invention is also relevant to productivity improvements, efficiency enhancements, maintenance, safety and environmental considerations with regard to legacy machines. This is elaborated hereinbelow.

Continuous improvement and rapid advancement of technology occasions the procurement and installation of the latest machines/technology in almost every capital intensive enterprise. This cycle entails replacement of the old, outdated, obsolete and often expensive installations or legacy machines, which are scrapped much before their expected life-term. These legacy machines are torn apart at the end of their service life and sold for the metal or elemental scrap value, booking losses to the original buyer. The primary reasons for scrapping are that newer technology/machines are far more efficient, can turn out a higher output in lesser time, are less labour intensive, more automated or fully automatic, are compatible with modern software and hardware and also add value to the company's perception by investors and customers. This presents machine-owners with the constant need to replace legacy machine-systems, and the associated costs and loss of time that arise due to rapid obsolescence.

Another aspect of this disadvantage is that the expected life of any installed machine is cut shorter than the period over which it can be written off by depreciation. What is even worse is that their scrap value is in the negative. Furthermore, mere replacement is not an end in itself because the additional training needs and other incidentals work towards a cost overrun.

Additionally, modern machines engaged in the manufacturing or other processes are equipped with an array of apparatus and devices for the collection and display of status information. However, a large number of concerns operate using legacy machinery and other devices which are unequipped with such capabilities. The current surge in process-monitoring and intervention in the field of manufacturing and production machinery on the basis of metrics derived from such monitoring renders such legacy machines redundant in comparison to state of the art machinery.

Such old, outdated, obsolete machines are referred to herein as ‘legacy machines’. The term ‘legacy machines’ used in this specification means and includes any device, apparatus, machine, machine part, machine system or unit that is either contemporary or old, partially working, partly or fully obsolete or outdated or is unable to work to its full installed capacity or is impaired by absence or non availability of a part or component, having limited or no compatibility with 1^{st}, 2^{nd}, 3^{rd} generation or modern day computer hardware and software, or which does not match the efficiency, effectiveness or capability of state of the art technology. The said term legacy machine also includes any machine or machine unit that aids in manufacturing, production, machining, processing, computing, monitoring, controlling, assembling, dismantling, counting, sorting, applying, regulating or dissipating, consuming or generating power, force, work or any form of energy thereof, in any industry including but not limited to power, prospecting, mining, manufacturing, excavation, aviation, automobile, chemical, electronics, robotics, electrical, refining, retail, packaging, apparel, medical devices, pharmaceuticals and shipping, among others.

There are a number of drawbacks and cost disadvantages associated with the retention and use of such legacy machines in contrast to state of the art machines, such as, for example,
1. lower efficiency,
2. lower output,
3. more labour intensive;
4. less automation and
5. unequipped for adoption of, and incompatible with modern software and hardware.

Modern state of the art manufacturing and process machinery are equipped with an array of apparatus and devices and computing systems for the collection and display of process parameters and status. The current surge in process-monitoring and intervention in the field of manufacturing and production machinery on the basis of metrics derived from such monitoring renders such legacy machines redundant in comparison to state of the art machinery.

While several innovative devices, methods and models have been devised in the prior art with a focus on improving quality of output, reducing down-time, increasing productivity and output of machines by way of refining the performance parameters of existing machines, an overwhelming majority of such attempts have been intrusive, i.e. performed by interfering in at least one process step, generally in order to form part of a feedback loop, which in turn entails a series of re-routings, rescheduling, system and process overrides. This interference results in a disruption of the original operation plan which results in the need for renewed recast of the operation plan, cost and time overruns etc. There have also been attempts in the prior art to non-intrusively or non-invasively control and refine processes with a view to improving the quality of output. However, such attempts in the art have thus far not successfully addressed the problem of technology obsolescence in the face of rapid technological advance. Another drawback of the solutions available in the prior art (whether non-intrusive or otherwise), is that they are machine-specific or machine type-specific and are incapable of being extended beyond their narrow scope to other types of machinery. This again works out to present an expensive proposition to enterprises owning a diverse array of legacy or other machinery that is constantly challenged by stringent demands.

U.S. Pat. No. 6,507,765 by Scott Hopkins discloses a computer controlled system for manufacturing machines that incorporates real-time monitoring of said machines. The drawbacks are that it does not offer efficiency enhancement and productivity improvement. It also does not offer operational optimisation. It, furthermore, does not cater to productivity improvement and optimisation of legacy machines. It does not provide for a knowledge management system from a cross-sectional study of a multitude of machine types, correlating their performance parameters. The concept of a data warehouse of operational data based on machine monitoring by a set of non-invasive parameters and said pattern matching based thereupon that is provided in the present invention is not apparently present in the cited patent. It is also apparently machine specific and not broad-based to operational intelligence extending across different machine types as is the system of the invention.

In U.S. Pat. No. 6,615,103 by M Fujishima et al, a computerised maintenance management system is disclosed. The wear on the various driver mechanisms of the machine tool is monitored and compared with the expected life profile. Said comparison is carried out in a computer unit which provides information as to the remaining expected life of the driver mechanisms. In the subject invention, the comparison is with operational data harvested from other machines of the same and/or other species and not with a predetermined expected life. The monitoring, comparison and control in the present invention is holistic and is not limited to maintenance as in the above patent. The holistic system of the invention also covers performance upgrading of the machine(s) as also optimisation of its output and productivity.

In this specification, references to historical data in the context of comparison and matching are intended to include operational data patterns of the target machine/process, of other machine(s)/process(es) of the same species and of other species of machine(s) and process(es).

In U.S. Pat. No. 6,816,815 by Y Takayama, a computerised preventive maintenance system is described. The maintenance monitoring data gathered from the machine tools at the users' sites are communicated to the computer at the machine tool manufacturer's site through a wired or wireless network. Said computer at the manufacturer's site is referred to as the supervisory unit. The supervisory unit compares the monitored data with reference data therein and based on that issues maintenance instructions to the user units which are communicated to the user computers. Said reference data in the supervisory unit is not operational intelligence comprising historical and contemporary operational data of similar or other machines as in the present invention. The subject invention is different also in so far as the system of the invention is a holistic monitoring, control and productivity improvement and optimisation system.

The present invention is different also from U.S. Pat. No. 7,864,037 by L C G Miller on ‘Pattern-driven communication architecture’ in so far as the present invention carries out performance upgrades of the target machine which may be a legacy machine or otherwise. The present invention also generates increased output unlike the cited invention.

None of the above cited documents disclose a holistic solution as in the present invention. In sum, almost every solution available, is either focused on quality control or on process control, or both and essentially provide solutions to deterministic problems/scenarios, with no advances toward an on-site constructive functional upgrade of installed legacy/obsolete machine systems.

These inventors have carried out extensive studies and analysed machine systems used by a cross section of industries to compare the legacy machine systems with those that form the state of the art and to define the technical gap between them. Data gleaned from such study and analysis spanning over a multitude of machine types from a multitude of industries over several years continues to feed their data warehouse and knowledge management system. Data on combinations of attributes of performing machines, mined and analysed by these inventors revealed cognizable patterns that helped them develop operational intelligence in the manner of an expert system that has warehoused the various intrinsic and extrinsic performance parameters of various machine-classes and their fuzzy interrelationships.

These inventors have invented a scientific and workable apparatus and a method to non-invasively collect, interpret and analyse multidimensional extrinsic functional attributes of diverse legacy machine systems, and to technically upgrade, modulate and optimize their performance parameters and output in real-time, by applying operational intelligence mined from a data warehouse developed and maintained for the purpose, so as to defer obsolescence, extend productive life and obviate replacement of outdated legacy machine systems that is occasioned by rapid advance in technology and to thereby obviate the cost (of capital outlays, installation, training, maintenance and de-risking), and time associated with such replacement.

These inventors have developed an apparatus and a process that is machine-class and type agnostic and generic in that it embraces and caters to a multitude of machine classes and machine types, and can operate without human intervention.

While the invention is focused on the productivity improvement and efficiency enhancement of said legacy machines, the scope of this invention however, without limitation, extends even to modern state of the art non-legacy machines where also said productivity and efficiency improvements can be realised by the application of this invention.

The terms non-invasive and non-intrusive have been used to convey the same or similar literal meanings and may be construed thus, according to the context.

### OBJECTS OF THE INVENTION

The main object of this invention is therefore to extend the life and productivity of obsolescent and outdated legacy machine systems by enhancing their performance parameters; modulation and optimization of output by non-invasive means, thereby bridging the technology-gap between legacy and state-of-the-art machine systems, and to devise apparatus and method for improving machine performance(s) that is generic in that it caters to a multitude of machine types/classes.

Another main object of this invention is to devise a control method or loop wherein operational parameters (attributes) from a chemical, mechanical, biochemical or any other process is collected and compared with one or more sets of historical and/or contemporary data of the said process or other similar process such as to generate optimized control parameters for modulating, upgrading and influencing said process.

Another object of this invention is to obviate frequent maintenance and replacement of installed machinery, otherwise occasioned by rapid change in technology, thereby reducing associated costs, time and additional training needs.

A further object of this invention is to enhance the salvage value of legacy machine systems by virtually upgrading the hardware to match state of the art machine performance.

A further object of this invention is to continuously monitor machine performance, non-invasively, based on one or more operational attributes, preferably extrinsic, thereof so as to modulate, augment, enhance or optimize performance, capacity and output which was beyond the scope envisaged by its manufacturer by harnessing operational intelligence developed overtime.

A further object of this invention is to effect such monitoring and corrective technical upgrades, enhancements and optimization in real-time, whereby the actual process analysis happens in a remote central server, or optionally the user company can deploy such a server on-site.

A further object of this invention is to provide for supplemental statistical process control of various sub-processes carried out by legacy machines.

A further object of this invention is to deploy appropriate sensors or such other detectors and to identify sources of said operational intelligence date and to collect such data. Such data may be, but not limited to, optical, acoustic, pulse, stress, electrical, electronic, radar, weather, thermal, chemical, flow rate, and/or any other form of physical data including photographs, thermal imaging, magnetic imaging, barcodes, holograms, trademarks, logos, other audio-visual patterns or combinations thereof, and extending to pre-processed data from other computation or other devices.

Another object of this invention is to execute the process steps of data collection, collation, data-mining and technical upgrade and/or optimization automatically and without manual intervention.

It is a further object of this invention to adapt, evolve and extend its operational intelligence to additional parameters and variables on an ongoing basis and to also accommodate and integrate further plug-ins or external computational resources with changing requirements of technology.

It is a further object of this invention to optionally provide for a manual interface to effect technical upgrades, augmentation or optimization of target machine performance by indicating graphical or other signals of possible hazards and warnings in advance.

It is yet another object of this invention to cause a technical effect in the target machine system, including but not limited to: enable, disable, stop operation, start operation, decrease operation execution rate, increase operation execution rate, engage warning indicator, disengage warning indicator, or to vary the rate of one operation or process in relation to another.

A further object of this invention is to optionally provide a comprehensive panoramic online graphic or other display of the intrinsic performance parameters of the target machine system as a dashboard for the user/supervisor, and to highlight situations when this inventive apparatus deduces possible future event occurrences and to set off triggers to alert the user/supervisor prior to the occurrence of a tagged event (rather than after such occurrence).

A further object of this invention is to compute and assign upper and lower specification limits of a given performance or process, to the target machine system through the apparatus and to influence the output accordingly by means of implementing or refining inventory tracking & management, supply chain management, overall process management.

A further object of this invention is to assume control of a legacy or other machine, being a manual, semi-automatic or automatic machine type, and to customize individual sub-processes of such target machine system by varying the processing rates or combinations thereof.

A further object of this invention is to generate alerts for, as well as to carry out, preventive, predictive, corrective and periodic maintenance of the target machine systems, automatically or manually.

A further object of this invention is to provide event and sub-event logs, inventory tracking, and process tracking of the legacy machines in the form of audit trails, and reports whereby such complete traceability of entire processes can fulfill relevant regulatory requirements.

A further object of this invention is to offer a machine-agnostic and generic solution by catering to a multitude of machine classes and machine types, to offer solutions to both deterministic and probabilistic problem concepts.

A further object of this invention is to develop and maintain a directory of information that presents ‘standards’ of operation metrics and their combinations thereof, arrived at from cross-sectional on-line monitoring of machine types and classes, so as to afford a novel avenue to users of this technology to compare their machine's performance with real-time contemporary operating industry standards. Such standards may include and are not restricted to various operation metrices including and not limited to production efficiency, productivity, profitability, performance, output, consumption, speed, start-up times, down times, inventory turn-overs etc., that are factual statistical parameters, including but not limited to average, weighted average, correlation factors etc., rather than the ideal/notional expectations provided by the manufacturer.

Another object of this invention is to provide remote access of shop floor goings-on to an off-site supervisor through the service provider's installation.

### STATEMENT AND SUMMARY OF THE INVENTION

According to the first aspect of the invention, there is provided a device for use in a control, management and optimisation system that is connectable to, or interfaceable with a set(s) of one or more industrial machines and/or processes, said system providing the control input(s) and signal output(s) for one, more or all of the undermentioned functions:
a. signal output(s) for displaying/broadcasting instructions/programme for maintenance of said machine(s) according to a preventive, predictive or other system of maintenance and for activation of a system of maintenance alarms/annunciators/indicators to indicate present and oncoming maintenance-related events;
b. control input(s) for augmenting said machine(s)' productivity and signal outputs for parametric indicators thereof;
c. control input(s) for improvement of the operational efficiency of said machine(s) and signal outputs for parametric indicators thereof;
d. control input(s) for optimisation of the performance of said machine(s) and signal outputs for parametric indicators thereof;
e. control input(s) for improvement of environmental impact(s) thereof and signal outputs for parametric indicators thereof; and
f. signal output(s) for activation of a system of safety alarms/annunciators/indicators to indicate present and oncoming safety-related events;

said device being connectable to one or more sensors connected to, or interfacing with, said machines, the function thereof being:
i. collecting, logging, converting and relaying, as necessary, the data of one or more of the intrinsic and/or extrinsic operational attribute(s)(parameters) thereof; and
ii. converting, upgrading, modulating and analysing said data from item (i), as necessary, and relaying thereof to a server for comparison/matching thereof with reference data,

said comparison/matching of the data from item (ii) with reference data, comprising multi-variate correlation analysis, thresholding and symbolic and non-symbolic pattern matching of one or more of individual said data and/or patterns and sequences thereof that constitute event(s) and phenomenon(a) therein, and generating control inputs and/or signal output(s) for carrying out one or more of the functions (a) to (f) mentioned hereinabove,

said reference data being preferably operational intelligence comprising historical and/or contemporary operational data harvested from said machine(s) and/or others of the same or other species and housed in said server or drawn from a central data warehouse, and said comparison and signal generation being carried out in real-time or otherwise.

According to the second aspect of the invention, there is provided a control, management and optimisation system that is connectable to, or interfaceable with a set(s) of one or more industrial machines and/or processes, said system providing the control input(s) and signal output(s) for one, more or all of the undermentioned functions:
a. signal outputs for displaying/broadcasting instructions/programme for maintenance of said machine(s) according to a preventive, predictive or other system of maintenance and for activation of a system of maintenance alarms/annunciators/indicators to indicate present and oncoming maintenance-related events;
b. control input(s) for augmenting said machine(s)' productivity and signal outputs for parametric indicators thereof;
c. control input(s) for improvement of the operational efficiency of said machine(s) and signal outputs for parametric indicators thereof;
d. control input(s) for optimisation of the performance of said machine(s) and signal outputs for parametric indicators thereof;
e. control input(s) for improvement of environmental impact(s) thereof and signal outputs for parametric indicators thereof;
f. signal output(s) for activation of a system of safety alarms/annunciators/indicators to indicate present and oncoming safety-related events;

and comprising a first device connectable to one or more sensors connected to or interfacing with said machines, and having the function of:
i. collecting, logging, converting and relaying, as necessary, the data of one or more of the intrinsic and/or extrinsic operational attribute(s)(parameters) thereof; and
ii. converting, upgrading, modulating and analysing said data from item (i), as necessary, for comparison/matching thereof with reference data and relaying thereof to a server,

and a second device being the said comparison/matching device, referred to herein as a server for comparison/matching of the data from item (ii) with reference data, said comparison comprising multi-variate correlation analysis, thresholding and symbolic and non-symbolic pattern matching of one or more of individual said data and/or patterns and sequences thereof that constitute event(s) and phenomenon(a) therein, and generating control inputs and/or signal output(s) for carrying out one or more of the functions (a) to (f) mentioned hereinabove, said reference data being preferably operational intelligence comprising historical and/or contemporary operating data harvested from said machine(s) and/or others of the same or other species and housed therein or drawn from an external centralised operational data warehouse; said comparison and signal generation being carried out in real-time or otherwise.

According to the third aspect of the invention, there is provided a method of control, management and optimisation of the performance of a set(s) of one or more industrial machines or processes, comprising providing the control input(s) and signal output(s) for carrying out one, more or all of the undermentioned functions:
a. signal inputs for displaying/broadcasting instructions/programme for maintenance of said machine(s) according to a preventive, predictive or other system of maintenance and signal output(s) for activation of a system of maintenance alarms/annunciators/indicators to indicate present and oncoming maintenance-related events;
b. control input(s) for augmenting said machine(s)' productivity and signal outputs for parametric indicators thereof;
c. control input(s) for improvement of the operational efficiency of said machine(s) and signal outputs for parametric, indicators thereof;
d. control input(s) for optimisation of the performance of said machine(s) and signal outputs for parametric indicators thereof;
e. control input(s) for improvement of environmental impact(s) thereof and and signal outputs for parametric indicators thereof;
f. signal output(s) for activation of a system of safety alarms/annunciators/indicators to indicate present and oncoming safety-related events;

said method comprising a first stage for:
i. collecting, logging, converting and relaying, as necessary, the data of one or more of the intrinsic and/or extrinsic operational attribute(s)(parameters) thereof; and
ii. converting, upgrading, modulating and analysing said data from item (i), as necessary, for comparison thereof with reference data;

and a second stage for:
a. comparing/matching said data from item (ii) with reference data, said comparison comprising multi-variate correlation analysis, thresholding and symbolic and non-symbolic pattern matching of one or more of individual said data and/or patterns and sequences thereof that constitute event(s) and phenomenon(a) therein, and
b. generating control inputs and/or signal output(s) for carrying out one or more of the functions (a) to (f) mentioned hereinabove,

said reference data being preferably operational intelligence comprising historical and/or contemporary operating data harvested from said machine(s) and/or others of the same or other species and housed in an external centralised data warehouse or drawn/downloaded therefrom and housed in a local or remote server; said comparison and generation of said control input(s) and signal output(s) being carried out in real-time or otherwise in said data warehouse or a local or remote server.

According to the fourth aspect of the invention, there is provided a method of transforming of the operational data of one or more of the intrinsic and/or extrinsic operational attributes of a set(s) of one or more industrial machine(s) and/or processes for use in a control, management and optimisation system thereof such as to provide the control input(s) and signal output(s) and the generation of the required metrics for carrying one, more or all of the undermentioned functions and others:
a. signal inputs for displaying/broadcasting instructions/programme for maintenance of said machine(s) according to a preventive, predictive or other system of maintenance and for activation of a system of maintenance alarms/annunciators/indicators to indicate present and oncoming maintenance-related events;
b. control input(s) for augmenting said machine(s)' productivity and signal outputs for parametric indicators thereof;
c. control input(s) for improvement of the operational efficiency of said machine(s) and signal outputs for parametric indicators thereof;
d. control input(s) for optimisation of the performance of said machine(s) and signal outputs for parametric indicators thereof;
e. control input(s) for improvement of environmental impact(s) thereof and signal outputs for parametric indicators thereof;
f. signal output(s) for activation of a system of safety alarms/annunciators/indicators to indicate present and oncoming safety-related events;

comprising,
i. providing sensors and/or transducers for the said one or more of the intrinsic and/or extrinsic operational attributes(parameters) of one or more said industrial machines or processes, that are connected to/or interfacing therewith for the generation of operational data thereof,
ii. receiving the said operational data and where necessary storing the same;
iii. conversion of the analogue data if any into digital;
iv. conversion of the streaming or logged data from item (iii) into a form suitable for comparison/matching thereof with reference data comprising operational data harvested from said machine(s) and/or others of the same or other species in a local or remote server or a remote data storage warehouse server accessed through a networking system such as the Internet, said form comprising individual data and/or patterns and sequences thereof that constitute events(s) and phenomenon(a) therein, and said comparison being by means of multi-variate correlation analysis, thresholding and symbolic and non-symbolic pattern matching and being in real-time or otherwise;
v. exporting the said processed data to a said server for carrying out said comparison/matching and generating the required metrics and control response(s) for carrying out one or more, or all, of said control, management and optimisation functions (a) to (f),

said reference data being preferably operational intelligence comprising historical and/or contemporary operational data harvested from said machine(s) and/or others of the same or other species and housed in said server or drawn from a central data warehouse, and said comparison and signal generation being carried out in real-time or otherwise.

According to the fifth aspect of the invention there is provided a method of processing of the operational data of one or more of the intrinsic and/or extrinsic operational attributes of a set(s) of one or more industrial machines and/or processes for use in a control, management and optimisation system thereof such as to provide the control input(s) and signal output(s) and the generation of the required metrics for carrying out for one, more or all of the undermentioned and/or other functions:
a. signal output(s) for displaying/broadcasting instructions/programme for maintenance of said machine(s) according to a preventive, predictive or other system of maintenance and for activation of a system of maintenance alarms/annunciators/indicators to indicate present and oncoming maintenance-related events;
b. control input(s) for augmenting said machine(s)' productivity and signal outputs for parametric indicators thereof;
c. control input(s) for improvement of the operational efficiency of said machine(s) and signal outputs for parametric indicators thereof;
d. control input(s) for optimisation of the performance of said machine(s) and signal outputs for parametric indicators thereof;
e. control input(s) for improvement of environmental impact(s) thereof and signal outputs for parametric indicators thereof; and
f. signal output(s) for activation of a system of safety alarms/annunciators/indicators to indicate present and oncoming safety-related events;

said processing comprising one, more or all of the following operations:
i. normalising said operational data for the purposes of comparison with historical data (of the target machine/process, machines and/or processes of the same species and/or of other machines and/or processes), and the analysis thereof;
ii. selectively filtering, classifying and selecting historical data using present operational data;
iii. evaluating/rating the current performance of the said machine(s)/process(es) relative to historical performance;
iv. normalising said operational data for carrying out comparative analysis across different species of said machine(s)/process(es);
v. generating control input(s) for performance upgrading of said machine(s)/process(es); and
vi. anonymising said operation data of machine(s)/processes in order to mask the identity of the specific machine/process and the user.

### DETAILED DESCRIPTION OF THE INVENTION

This invention provides for a control, management system for a machine and/or a process. Said system incorporates the devices, apparatus and methods of the invention. The system monitors one or more phenomena related to the efficiency, productivity, operational state and environmental impact of the machine/process. Using appropriate sensors, the system collects and processes data relating to each such phenomena, analyses the data to reason over the activity of the manufacturing machine by comparing against known patterns of the machine/process's activity and effects inputs to the machine/process based on the said reasoning. The operation of the system of the invention is in real-time.

The input to the said system comprises sensory inputs from various sensing devices that measure one or more of the parameters(attributes) of the said machine or process.

Some of the sensory parameters that can be processed in the system of the invention are, but limited to, optical, acoustic emissions (AE), pulse, stress, electrical, electronic, radar, weather, thermal, chemical, flow rate, and/or any other form of physical data including photographs, thermal imaging, magnetic imaging, barcodes, holograms, trademarks, logos, other audio-visual patterns or combinations thereof, and extending to pre-processed data from other computation or other devices. Typically, some of the parameters that are measured in relation to machine tools are: power consumption, compressed air usage, air flow, particle exhaust, liquid exhaust, solid exhaust, consumable flow, acoustic emissions, ambient noise, vibrations, heat, temperature and light.

These sensory inputs are processed in the system of the invention to generate outputs. One set of such outputs constitutes what is referred to herein as control inputs. The generated control inputs are applied to the operational control parameters of the machine and/or the process such as to control the performance thereof and/or to enhance the performance and efficiency thereof and/or to optimise the said performance. Another set of said outputs comprises signal outputs that are applied to, and activate, a system of alarms, annunciators and indicators and other audio-visual systems. Said signal outputs comprising messages convey/announce the operational, maintenance, environmental impact and the health status of the machine/process. A comprehensive status survey covering all the factors mentioned, operation, maintenance, health and environmental is also provided by the system.

Some of said system outputs that can be generated by the system, but not limited to, are: enable device the machine(s) being controlled, disable device, stop operation, start operation, decrease operation execution rate, increase operation execution rate, engage warning indicator, engage fault indicator, disengage fault indicator and others.

The system of the invention is capable of processing both invasive and non-invasive sensory inputs. Preferably, the sensing devices are non-invasive as provided in the present invention.

In the widest scope, the various aspects of this invention and the devices, apparatus, method of control, management and optimisation and the methods of processing and converting operating data of machines and processes provided by the invention are applicable to any industrial machine(s) and/or process(es). Some of the industry sectors to which this invention may be applied simply and easily are: metals and metal working, power, prospecting, mining, manufacturing, excavation, aviation, automobile, chemical, electronics, robotics, electrical, refining, retail, packaging, apparel, medical devices, pharmaceuticals and shipping and other industries for functions such as machining and other aspects of metal cutting and metal working, manufacturing, production, processing, computing, monitoring, controlling, assembling, dismantling, counting, sorting, applying, generating, regulating, consuming or dissipating power, force, work or energy and others.

The invention is applicable to a machine and simultaneously to the process being carried out therein. It is applicable to sets of machines each comprising a plurality of machines. Such sets may comprise machines of one species or different. The invention is also applicable to chemical, metallurgical, biochemical, biotechnical and other processes.

Within the scope of the invention, the system of the invention does not necessarily have to incorporate therein all the devices, apparatus and methods provided by the invention. One or more elements may be as provided by the invention while the others may be of the type known in the art. Thus, within the scope of the invention hybrid arrangements are possible.

The further description hereinbelow is presented in the context of the application of the invention to a machine tool or a set of machine tools. This is in the interests of simplicity and conciseness and without limitation to the scope of the invention.

The control, management and optimisation system of the invention generates the required control input(s) and signal output(s) by means of which any one or more, or all of the following functions can be carried out:
a. signal output(s) for displaying/broadcasting instructions/programme for maintenance of said machine(s) according to a preventive, predictive or other system of maintenance and for activation of a system of maintenance alarms/annunciators/indicators to indicate present and oncoming maintenance-related events;
b. control input(s) for augmenting said machine(s)' productivity and signal outputs for parametric indicators thereof;
c. control input(s) for improvement of the operational efficiency of said machine(s) and signal outputs for parametric indicators thereof;
d. control input(s) for optimisation of the performance of said machine(s) and signal outputs for parametric indicators thereof;
e. control input(s) for improvement of environmental impact(s) thereof and signal outputs for parametric indicators thereof; and
f. signal output(s) for activation of a system of safety alarms/annunciators/indicators to indicate present and oncoming safety-related events;

The system of the invention broadly comprises a first and a second device. Said first device receives the operational data from the sensors/transducers that monitor the machine(s). In the said first device, necessary transformation/conversion of said data is carried out. Firstly, the data is made uniformly digital. The entire data is logged/stored for a pre-determined period of time. Conversion of the data is carried out such as to identify single data or sequences of data that represent patterns of behaviour of the machine and constitute event(s) and phenomenon(a). The pattern data is then exported to the said second device for comparison/matching such as to generate said control inputs and signal outputs.

Said second device is also referred to herein as the server. Said server may be a local server or a remote one. Alternatively, it may be a centralised server that serves a plurality of users and machines. Said centralised server constitutes the database of operational data of different machines which may be of the same species as the machines being controlled or others. Combination of the two procedures is also adopted and is within the scope of the invention.

Said data in the data warehouse server and the patterns developed/identified therefrom is referred to herein as the reference data. Said comparison/matching of the data from said first device is done with said reference data, and involves multi-variate correlation analysis, thresholding and symbolic and non-symbolic pattern matching of one or more of individual said data and/or patterns and sequences thereof that constitute event(s) and phenomenon(a) therein. Said comparison/matching generates control inputs and/or signal output(s) for carrying out one or more of the functions (a) to (f) mentioned hereinabove. Said matching and data analysis also generates one or more metrics that represent quantitatively and/or qualitatively the status of the target machine as regards machine performance, health status, risk status, safety status, maintenance status and combinations of these criteria.

Thus, within the scope of the invention, the system of the invention may comprise said first and second devices. The said second device being the server may also be a said data warehouse wherein said pattern comparison, recognition and matching is carried out. Within the scope of the invention, the said system may comprise said first device and the centralised server.

Alternatively, the system may comprise the said first device alone with the centralised server, the latter being outside the system. In an optional arrangement, a local/remote server is interposed between the said first device and the central warehouse server.

The system maintains a persistent connection with the servers and communicates realtime operational data thereto. The server receives data from the said system and stores it in a high speed database. Patterns from the machines being monitored are compared against master patterns stored in the said central warehouse master server or the local and remote servers. The data in the warehouse server used for said comparison/matching is continuously updated and the said master patterns modified periodically or continuously as the new operational data streams in. Thus, the said operational data in the operational intelligence database of the invention may be historical and/or contemporary. It may be periodically or continuously upgraded by new contemporary data harvested from a variety of machines.

Within the scope of the invention, some or all of the functions of said first device may be carried out in the second, namely, the servers, including the centralised server. Also, within the scope of the invention, a combination of said first and second devices is also feasible and the combined device may be a single unit. The division of the functions into more than two devices is also within the scope of the invention.

The first aspect of the invention, discloses a device carries that out said functions of sensory data collection, logging, converting into said pattern data and communicating the same to the server for said comparison/matching. The said functions (a) to (f) are self-explanatory. As mentioned, the system of the invention can generate outputs for individual functions as also for any combination thereof. Preferably, said sensors are non-invasive as in the preferred embodiments of the invention.

Preferably, the invention provides for the monitoring of the instantaneous values of the power parameters of the target machine, such as voltage, amperage, wattage and the power factor. Preferably, all the four variables are monitored. More preferably, the following attributes are additionally monitored: the instantaneous compressed air flow and the consumable flow. This aspect provides for a said device that can be linked to a local server, or a remote server or the said remote data warehouse server. Said device may be unitary and portable and may also incorporate the server function within the scope of the invention.

The second aspect of the invention provides for the said control, management and optimisation system of the invention. Said system comprises said first and second devices but within the scope of the invention may comprise a single device that combines the functions of the two. The function of the said second device is analysing the processed operational data of the target machine from the first device and comparison thereof with said reference data. Said second device is, of course, what has been referred to as the server hereinabove. This aspect provides for the same preferable non-invasive attributes, as also the same additional attributes as in the first aspect.

The third aspect of the invention provides for the method of said control, management and optimisation of the target machine(s). Said method may be implemented by adopting the said first and second devices or by other variants indicated/claimed. Any division of the functions between the two devices is within the scope of the invention. An integrated unitary device combining the two devices is also provided in this aspect. The same preference as regards the non-invasive attributes is provided in this aspect as also in all the other aspects of the invention that follow. The first and second devices together are referred to herein as the apparatus of the invention.

The fourth aspect of the invention covers the various performance evaluation metrics and metrics for evaluations based on other criteria. This aspect provides for the method to obtain said metrics by suitable transformations of the operational performance data received from the sensors. The first set of said metrics comprises those related to production such as, but not limited to,
a. production efficiency;
b. material and machine utilisation;
c. production cycle time;
d. downtime;
e. good parts count;
f. bad parts count;
g. total parts count;
h. production time;
i. non-process production time,
j. process time,
k. consumable consumption rate, and
l. accessory usage rate.

This provides the basis for configuring a status report of the target machine with regard to production performance, efficiency and productivity.

The second set of metrics covers safety-related parameters and comprises, but not limited to,
m. probability of injury to a user/operator;
n. probability of damage to the surrounding environment at the workplace;
o. probability of internal damage to the said machine(s);
p. probability of damage to the workpiece(s); and
q. probability of damage to the consumables such as, for example, the toolings,

and provides the data for preparing a status report on the target machine with regard to the safety aspects thereof.

The third set covers maintenance-related metrics and comprises, but not limited to,
r. time available before probable failure of the machine tool and each of the components thereof;
s. probability of imminent failure of the tool system;
t. health rating of the tool system between 0% and 100%, the former indicating probable imminent failure and the latter, perfect condition thereof;
u. probable time before the next failure of machine tool consumables;
v. consumables usage rate;
w. machine tool wear rate; and
x. machine tool accessory wear rate.

The data generated by this set of metrics is co-ordinated to project audio-visually a visualisation of the maintenance status of the target machine and a status report.

The fourth set of metrics forms the basis for providing a comprehensive status report on the target machine covering production performance, maintenance, safety and other considerations. The set of metrics that are evaluated in this set are, but not limited to, all the metrics provided in the said first, second and third sets. The full complement of metrics enshrined in said first, second and third sets is not listed herein in the interests of conciseness and is without limitation to the scope of the invention.

The fifth aspect of the invention provides for a method of transforming the said operational data by means of six procedures which are described hereinbelow:
a. normalising said operational data for the purposes of comparison with historical data (of the target machine/process, machines and processes of the same species and/or of other machines and processes), and the analysis thereof;
b. selectively filtering, classifying and selecting historical data using present operational data;
c. evaluating/rating the current performance of the said machine(s)/process(es) relative to historical performance;
d. normalising said operational data for carrying out comparative analysis across different species of said machine(s)/process(es);
e. generating control input(s) for performance upgrading of said machine(s)/process(es); and
f. anonymising said operation data of machine(s)/processes in order to mask the identity of the specific machine/process and the user.

The method may include any one or more, or all of said procedures.

In the first procedure the incoming operation data is converted into a format suitable for comparison with historical data sets, involving the identification and removal of non-standard data artifacts such as peaks, identification and marking of artifacts that distinguish the present data from the historical, and normalising based on key statistical parameters such as mean and standard deviation and spatial and temporal transformations using geometrical parameters.

The second procedure involves identifying, filtering and classifying current(present) data such as to select suitable historical data for comparison thereof therewith; identifying suitable historical data on the basis of one or more factors selected from, but not limited to, frequency analysis, spectral analysis, motif detection analysis, symbolic and non-symbolic pattern recognition and peak detection, classifying and tagging historical data using both qualitative and quantitative means based on the criteria of the level of matching thereof with said present data sets and ranking and filtering said tagged and classified historical data sets on the basis of the suitability thereof for said comparison, and analysis.

The third procedure comprises constructing a numerical function denoting the historical baseline performance data, convolving a plurality of such historical data using statistical mapping and averaging to create a single historical baseline data, analysing said baseline data to detect pertinent and relevant patterns that relate performance, health, risk and status attributes of the machine(s)/process(es).

The steps in the fourth procedure are: normalisation of the said operational data into a format suitable for comparison across different historical data sets of different machines/processes, including removal of non-standard data artifacts such as peaks, identification and marking of artifacts that distinguish the current(present) data from historical data and differentiating operation data based on key statistical parameters such as the mean and standard deviation, and spatial and temporal transformations using geometrical parameters.

The operational steps in the fifth procedure are:
(i) collecting current performance data of said machine(s) and/or process(es);
(ii) collecting/downloading said historical data for said machine(s) and/or process(es); and
(iii) comparing the data of (i) and (ii) to generate control input(s) to effect a technical upgrade of the performance of the said machine(s) and/or process(es) to the level of the said historical data of (ii), said input(s) being one or more commands such as, but not limited to, to stop the machine operation, increase/decrease feedrate, increase/decrease spindle speed, issuing of a warning, to engage the ESTOP trigger and others.

The sixth procedure covers the processing steps necessary for the anonymisation of the data. The anonymisation of the said operation data of the machine(s) and/or process(es) is achieved by the removal of unique and idiosyncratic markers and other distinguishing features, if any, therein such as to substantially prevent determination, by an unrelated third party, of the specific identity of the said machine(s)/process(es), the nature of the operation, the identity of the user, the geometry, material and other characteristics of the part/product being made and the nature and identity of the consumables and accessorised being used. The operations involved in anonymisation are, but not limited to, calculating differences between realtime data and a function-based baseline average, de-noising, phase-shifting and others.

In order to provide a clearer understanding of the invention and without any limitation to the scope of the invention, a few embodiments thereof are described hereinbelow.

### Embodiment 1

This embodiment is the complete system of control, management and optimisation as provided in the invention. Said system incorporates, in addition, the method of the invention to treat said operation data to generate said metrics and the method to carry out said procedures (i) to (iv). It comprises the first and second devices of the invention and the system as a whole constitutes the apparatus of the invention.

The system of the invention comprises the undermentioned features:

1. Data collection and control device comprising:
a. storage/memory,
b. Processor,
c. Output control,
d. Sensor underface using industrial connections,
e. wireless communication,
f. Wired network communication,
g. Human machine interface/visual display unit,
h. Internet-enabled server(s) to store and process comparable and historical data,
i. Network interfaces between data collection devices and servers.

Item 1 above is the said first device of the invention for carrying out the functions and having the features (a) to (g).

Item 2 above is the said second device of the invention and the items 1 to 3 together represent the apparatus of the invention, which is installed, in the said processor and the server, with the required software to carry out, but not limited to, the belowmentioned functions (a) to (f).
a. signal output(s) for displaying/broadcasting instructions/programme for maintenance of said machine(s) according to a preventive, predictive or other system of maintenance and for activation of a system of maintenance alarms/annunciators/indicators to indicate present and oncoming maintenance-related events;
b. control input(s) for augmenting said machine(s)' productivity and signal outputs for parametric indicators thereof;
c. control input(s) for improvement of the operational efficiency of said machine(s) and signal outputs for parametric indicators thereof;
d. control input(s) for optimisation of the performance of said machine(s) and signal outputs for parametric indicators thereof;
e. control input(s) for improvement of environmental impact(s) thereof and signal outputs for parametric indicators thereof; and
f. signal output(s) for activation of a system of safety alarms/annunciators/indicators to indicate present and oncoming safety-related events;

The installed software also gives the system of the invention the capacity to generate said metrics. The set of metrics that can be generated by the system of the invention comprises, but not limited to, the said fourth set of metrics comprising items (a) to (x) referred to hereinabove. The same is not repeated here in the interest of conciseness. Said metrics provide the basis for the evaluation of the machine(s)/process(es) from the point of view of performance, safety, environmental impact, maintenance and other criteria.

Said installed software also provides the capacity to carry out said data transformations which comprise, but are not limited to:
i. normalising said operational data for the purposes of comparison with historical data (of the target machine/process, of other machines and processes of the same species and/or of machines and processes of other species), and the analysis thereof;
ii. selectively filtering, classifying and selecting historical data using present operational data;
iii. evaluating/rating the current performance of the said machine(s)/process(es) relative to historical performance;
iv. normalising said operational data for carrying out comparative analysis across different species of said machine(s)/process(es);
v. generating control input(s) for performance upgrading of said machine(s)/process(es); and
vi. anonymising said operation data of machine(s)/processes in order to mask the identity of the specific machine/process and the user.

The wider system of the invention comprises the following:
i. the non-invasive data collection device;
ii. human-machine interface;
iii. analog sensors;
iv. digital sensors;
v. power meters;
vi. the target machine tool;
vii. production part quality measurement equipment;
viii. network interface;
ix. LAN;
x. the local server; and
xi. the remote server.

### Embodiment 2

This embodiment relates to the method of the invention for non-invasively collecting operational data from a machine tool relating to one or more attributes of the functioning of a machine tool and comprises the following parts:
i. a CNC Lathe Machine Tool(target machine),
ii. a power meter connected to the incoming 3-phase power leads for monitoring the instantaneous voltage, current and wattage in the three phases and the power factor,
iii. an air flow meter for monitoring(in Cubic Feet per Minute—CFM) the compressed air flow to the target machine tool,
iv. a consumable flow meter for monitoring the consumable fluid flow(in Gallons Per Minute—GPM) to the target machine,
v. the sensors and the sensor interfaces,
vi. the device for receiving the sensor signals and for converting the same,
vii. the local server connected to the device and the network connection thereof, and
viii. a data warehouse server connected to the local server.

The actions of the system of the invention are as follows:
a. The device collects voltage, current, wattage, power factor, instantaneous air flow (CFM) and the consumable flow data (such as a coolant) in GPM from the machine tool in realtime from the sensors. The air flow and the consumable flow data comes in as analog signals which are converted to digital in the device.
b. The device determines that the machine tool is operational when the wattage exceeds about 100 W. Upon this determination, the device generates an ASCII-formatted message of the format: “Device time/device status/operational. This message is communicated to the local server over a TCP socket.
c. If the wattage measurement is less than about 100 W, the device determines the machine tool as being not operational. Upon this determination, the device creates an ASCII-formatted message: Device time/device status/not-operational and communicates it to the local server over a TCP socket.
d. The device determines that the machine tool is actively producing a part when the wattage is greater than 1000 W, the air flow rate is greater than 5 CFM and the coolant flow rate is greater than 1 GPM. Upon this determination, the device creates an ASCII-formatted message of the format: Device time/execution status/producing and communicates it to the local server over a TCP socket.
e. When any of the conditions are not met, the device determines that the machine tool is not actively producing a part. Upon this determination the device creates an ASCII-formatted message: Device time/execution-status/not-producing and communicates it to the local server over a TCP socket.
f. The local server stores all received messages from the device locally and transports it to the remote server simultaneously after prefixing the device's unique identifier name to each ASCII text message.
g. The remote server stores all received messages in a central data warehouse.

### Embodiment 3

This embodiment relates to the method of the invention of transforming the operational data into performance evaluation parameters such as part production, utilisation, percent uptime of the machine and others.

The system comprises parts (i) to (viii) as enumerated in Embodiment 2.
a. same as item (a) of Embodiment 2.
b. The device determines the ‘utilisation’ of the device based on the percent time the machine tool has a wattage measurement greater than 1000 W. The utilisation metric is calculated every hour. The total duration of time in seconds spent when the wattage is greater than 1000 W is computed and stored in a memory variable. A timer triggers a computation of the utilisation metric hour units on the hour and every hour.
c. The device determines the ‘production time’ of the device based on the total duration of time the device spends when the wattage measurement is above 1000 W. The production time is incremented per second whenever the wattage measurement is greater than 1000 W.
d. The device determines the part count by enumerating every contiguous block of the time the wattage measurement is greater than 1000 W and the compressed air flow is greater than 5 CFM. Each contiguous block of time when both of these parameters are met is determined as the production of one part. The total part count for a day is computed as the total number of contiguous intervals of time when the wattage is above 1000 W and the compressed air flow exceeds 5 CFM.

### Embodiment 4

This embodiment demonstrates the method of the invention for transforming the operational data into metrics related to risk evaluation. The system comprises the parts (i) to (viii) enumerated in Embodiment 2.
a. The device collects the CFM and GPM data from the machine tool in realtime based on the sensor measurements. This data comes in as analog signals which is converted into digital.
b. The device determines that the machine tool is going to pose a high safety risk to the plant when the compressed air flow rate is greater than 50 CFM. A red LED light is illuminated in the device and a buzzer is sounded in a distinctive pattern (Pattern #1) when this condition is met. The device also displays the text: Warning: Compressed air flow rate excessive in its visual display unit when this condition is met.
c. The device determines that the machine tool is going to pose a moderate safety risk to the user when the coolant flow rate is greater than 10 GPM. An orange LED light is illuminated in the device and a buzzer is sounded in a distinctive pattern(Pattern #2) when this condition is met. The device also displays the text: Warning: Coolant flow rate is excessive in the visual display unit when this condition is met.

### Embodiment 5

This embodiment relates to the method of the invention for transforming the operational data into health (maintenance) evaluation. The system comprises the parts (i) to (viii) enumerated in Embodiment 2.
a. same as item (a) of Embodiment 2.
b. The device determines that a part is being produced by the machine when the wattage measurement is greater than 1000 W. If the average coolant flow rate for the entire duration a part was being produced was lesser than 1 GPM, the device determines that there is a high likelihood that the quality of the produced part was poor. If the average coolant flow rate for the entire duration a part was being produced was less than 10 GPM but greater than 1 GPM the device determines that there is a moderate likelihood that the quality of the part produced part was poor.
c. The device determines that the machine tool is in a poor health condition if the average coolant air flow rate measured every 15 min shows an increase or decrease of more than 5% cumulatively across a 24 hr period.
d. The device determines that the machine tool is in a good health condition if the average coolant air flow rate measured every 15 min stays within a 2% range across a 24-hr period.

### Embodiment 6

This embodiment relates to the method of the invention of transforming the operational data into status evaluation. The system comprises parts (i) to (viii) enumerated in Embodiment 2.
a. same as item (a) of Embodiment 2.
b. The device determines that the machine tool is in a poor health condition when the average coolant flow rate measured every 15 min shows an increase or decrease of more than 5% on average across a 24-hr period. Simultaneously, the device determines the ‘utilisation’ of the device as 40% for the last hour of operation based on the percent time the machine tool has a wattage measurement greater than 1000 W. This is determined as “low utilisation”. Based on the evaluation of ‘poor health’ and ‘low utilisation’ the machine tool's status is set as ‘Machine Tool in poor health: requires maintenance attention’. The red and orange light indicators are lit in an alternating pattern, and the buzzer emits sound in a distinctive pattern (Pattern #3). The device issues an email message directed to the shop floor maintenance personnel with the text “Machine Tool in poor health: requires maintenance attention”. In addition, this text is displayed in the visual display unit of the device.

### Embodiment 7

This embodiment relates to the method of the invention for normalizing machine tool data in order to perform historical comparisons and analysis. The system comprises parts (i) to (viii) enumerated in Embodiment 2.
a. The device collects voltage, current, wattage and power factor data from the machine tool in realtime through the sensors.
b. The device performs normalisation of wattage data based on negative power factor measurements. When the power factor is negative, the corresponding wattage values are filtered out when transporting the data to the local server.
c. The device performs normalisation of wattage data by identifying and removing instantaneous spikes. A spike is determined as any value of wattage that lasts for less than 2 seconds and is greater than 500% of the previous 60 second average wattage value. When spikes are identified in the wattage, the wattage values of the points identified as spikes are changed to the average value of the previous 60 seconds.
d. Voltage and amperage data normalisation is performed by subtracting the mean value of the voltage and amperage values calculated every 60 seconds from each instantaneous voltage and amperage value respectively and then dividing the resultant values by the standard deviation of the voltage and amperage values calculated every 60 seconds respectively.
e. The normalised data is expressed as ASCII text and communicated to the local server over a TCP socket. The local server stores the data and forwards it to the remote server, which in turn stores it in the data warehouse.

### Embodiment 8

This embodiment relates to the method of the invention for selectively filtering, classifying and selecting historical data using current operational data and to the method of the invention for evaluate the current performance of the machine relative to historical performance. The system comprises parts (i) to (viii) enumerated in Embodiment 2.
a. same as item (a) of Embodiment 2.
b. The device determines that a part is being produced by the machine when the wattage measurement is greater than 1000 W. Each contiguous interval of time when the wattage measurement is greater than 1000 W is ennumerated as one part.
c. The cycle time of the part is computed as the total contiguous duration taken for manufacturing one part, which is the total contiguous duration the wattage measurement is greater than 1000 W.
d. The device computes the average cycle time based on the cycle time taken for the last 100 parts produced on the machine tool.
e. The device analyses the instantaneous wattage during a single producing cycle and converts it into a relative symbolic representation. The wattage range during the producing cycle is divided into 5 equal bins denoted by letters A to E with A being the smallest bin range and E the largest. The producing cycle is represented using symbols A to E where each letter denotes the histogram bin in which the average wattage calculated across 3-second discretised intervals falls into. Thus, the wattage variation of each producing cycle is represented as a symbolic string of characters A to E. For, example, a 30-second long producing cycle is denoted as AEEEDDBCCA corresponding to a wattage range of 1000 W to 2000 W, where each A denotes 1000-1200 W, B denotes 1200-1400 W, C denotes 1400-1600 W, D denotes 1600-1800 W and E denotes 1800-2000 W.
f. The device communicates to the remote server through the local server as a means of identifying historical data from the same machine took, the following data:
   Average cycle time for the last 100 parts,
   Average per hour part count,
Machine tool health rating: average number of times per hour the air flow rate drops below 1 CFM or exceeds 10 CFM or coolant flow rate drops below 1 GPM.
   Symbolic representation for last 100 parts.
g. The remote server performs a filtering query on the historical data stored in the data warehouse to filter and select data from machine tools that match the machine tool identity sent from the device.
h. Further, the remote server identifies historical data that have a cycle time within 20% of the cycle time specified by the remote server.
i. The identified historical data set is now compared against the device's data using the relative symbolic representation for both the historical data and the device data. The historical data is assumed to be represented as symbolic data using the same parameters as the device's data. Each historical data set is compared against the current device data and the relative difference in the symbolic representation(computed using a character-distance function) is calculated and expressed as a percentage.
j. Based on the percentage, the historical data sets are ranked as follows:
   >90% Very good match,
   70%-90% good match,
   30%-70% moderate match, and
   <30% no match.
k. The server selects historical data sets that are ranked as Very Good Match and Good Match for the selected data from the device.
l. For these historical data sets, the following metrics are calculated
   Average Per-hour Part Count (number of Production Cycles per hour)
   Cycle Time (duration of Production Cycles)
   Machine Tool Health Rating
m. The apparatus evaluates the current performance of the machine relative to the historical performance by constructing a numerical function denoting the historical baseline performance of the machine tool. A plurality of historical data sets are convolved using statistical mapping and averaging to create a single historical baseline. The baseline is analysed to detect pertinent and relevant patterns that correspond to key performance, health, risk and status attributes of the machine tool. The current performance of the machine is evaluated by determining the presence or absence or relevant and pertinent patterns that are observed in the historical data set, and based on the differences between the patterns present in the current data and the historical data.
n. The server selects historical data sets that are ranked as very good match and good match for the selected data from device.
o. For these historical data sets, the metrics are calculated:
   average per hour part count (No. of production cycles per hour),
   cycle time (duration of production cycles),
   Machine tool health rating.
p. A statistical distribution is created for each of these parameters and the percentile value corresponding to the machine tool's current part count, cycle time, and machine tool health rating in the historical statistical distribution is computed.
q. Based on the percentile value, the performance of the current machine tool is rated:
   90% very good performance relative to history,
   70%-90% good performance relative to history,
   30%-70% comparable performance relative to history,
   <30% poor performance relative to history.

### Embodiment 9

This embodiment relates to the method of the invention for normalising machine tool data to perform comparative analysis across different machine tools. The system comprises parts (i) to (viii) enumerated in Embodiment 2.
a. same as item (a) of Embodiment 2.
b. The device performs normalisation of wattage based on negative power factor measurements. When the power factor is negative the corresponding wattage values are filtered out when transporting the data to the local server.
c. The device performs normalisation of wattage data by identifying and removing instantaneous spikes. A spike is determined as any value of wattage that lasts for less than 2 seconds and is greater than 300% of the previous 60 second average value. When spikes are identified in the wattage, the wattage value of the identified points are changed to the average wattage value of the previous 60 seconds.
d. Voltage and amperage data normalisation is performed by subtracting the mean value of the voltage and amperage values calculated every 60 seconds from each instantaneous value of voltage and amperage respectively. The resultant values are then divided by the standard deviation of the voltage and amperage values calculated every 30 seconds respectively.
e. The normalised data is expressed as ASCII text and communicated to the local server over a TCP socket. The local server stores the data and forwards it to the remote server, which in turn, stores it in the data warehouse.
f. Along with the normalised data, the remote server stores the machine tool's identity consisting of comprising of type, make, model and year.

### Embodiment 10

This embodiment relates to the method of the invention for selectively filtering, classifying, and selecting comparable machine tool data using current operational data and the method of the invention for evaluating the current performance of the machine relative to comparable machine tool performance. The system comprises parts (i) to (viii) enumerated in Embodiment 2.
a. same as item (a) of Embodiment 2.
b. The device uniquely identifies the machine tool connected to as a CNC Lathe machine took, manufacturer Takisawa, Model TC 200, Year 1996. This information is entered into the device by a human operator who configures the device.
c. The device determines that a part is being produced by the machine when the wattage measurement is greater than 1000 W. The cycle time of the part is computed as the total contiguous duration taken for manufacturing one part, which is the total contiguous duration the wattage measurement is greater than 1000 W.
d. The device computes the average cycle time based on the cycle time taken for the last 100 parts produced on the machine tool.
e. The device analyses the instantaneous wattage during a single producing cycle, and converts it into a fixed symbolic representation. The wattage range during the producing cycle is divided into bins wherein each bin has a width of 100 W. Bin A 0-100 W. Bin B from 101 to 200 W and so on. For values that range beyond the symbol Z, the symbols are subscripted as A₁, B₁ Z₁ followed by A₂, B₂ and so on. The wattage variation of each producing cycle is represented as a symbolic string of characters. For example a 15 sec long producing cycle is denoted as DBQ₃G₂B₁.
f. The device communicates to the remote server through the local server as a means of identifying comparable machine tool data the following data:
   machine tool identity comprising of type, make, model and year,
   average cycle time for last 100 parts,
   average per hour part count;
   machine tool health rating-average number of times per hour the air flow rate drops below 1 CFM or exceeds 10 CFM or the coolant flow rate drops below 1 GPM.
   symbolic representation for last 100 parts.
g. The remote server performs a filtering query on the comparable data stored in the data warehouse to filter and select data from machine tools that match the machine tool identity sent from the device.
h. Furthermore, the remote server identifies comparable data that have a cycle time within 20% of the cycle time specified by the remote server.
i. The identified comparable data set is now compared against the device's data using fixed symbolic representation for both the historical data and the device data. The comparable data is represented as symbolic data using the same representation set as the device's data. Each comparable data set is compared against the current device data and the relative difference in the symbolic representation(computed using a character-distance function) is calculated and expressed as a percentage.
j. Based on the percentage, the comparable data sets are ranked as follows:
   >90% very good match,
   70%-90% good match,
   30%-70% moderate match,
   <30% no match
k. The server selects comparable data sets that are ranked as very good match and good match for the selected data from the device.
l. For these comparable data sets, the following metrics are calculated.
   average per hour part count(number of production cycles per hour)
   cycle time(duration of production cycles),
   machine tool health rating.
m. A statistical distribution is created for each of these parameters and the percentile value corresponding to the machine tool's current part count, cycle time and machine tool health rating in the historical statistical distribution is computed.
n. Based on the percentile value, the performance of the current machine tool is rated:
   >90% very good performance relative to history,
   70%-90% good performance relative to history,
   30%-70% ccomparable performance relative to history,
   <30% poor performance relative to history.
o. Using the above rating, performance is rated for production rate using the average per hour part count metric, productivity using the cycle time metric, and health using the machine tool health rating metric.

### Embodiment 11

This embodiment relates to the method of the invention for providing appropriate control outputs for providing performance upgrades to the machine tool using:
a. current performance data,
b. historical data, and
c. comparable machine tool data.

The system comprises parts (i) to (viii) enumerated in Embodiment 2. The local server is connected to a remote server across the internet.
a. same as in item (a) of Embodiment 2.
b. The device determines that the machine tool is going to pose a high safety risk to the plant when the compressed air flow is greater than 50 CFM. A red LED light is illuminated in the device and a buzzer is sounded in a distinctive patter(Pattern #1) when this condition is met. The device also displays the text: Warning: Compressed airflow rate excessive in its visual display unit when this condition is met. If the compressed air flow rate does not decrease after 300 sec of triggering the LED, buzzer, and text, the device sends a 24V DC control input to the machine tool to temporarily pause operation of the machine tool. The control signal is disabled only after the device recognises that the compressed air flow rate is less than 50 CFM for a minimum of 600 sec.
c. The device determines that the machine tool is producing a part while suffering through increased mechanical wear when the wattage is greater than 2000 W and is steadily increasing at a rate of over 2% over a 600 sec period. When such a determination is made the device sends a “ESTOP” command to the machine tool using a 24V DC control input and triggers the emergency stop command in the machine tool. The control signal is disabled only after the device recognises that the wattage value does not increase at a rate greater than 1% for minimum duration of 600 sec.
d. Using the working embodiment outlined above, if the machine tool is rated to be in low performance relative to productivity when compared against historical or other comparable machine tools, a status message is displayed in the visual display unit as follows, “Please increase productivity, productivity lower than average”.

### Embodiment 12

This embodiment relates to the method of the invention for anonymising machine tool data in order to mask the identity of the specific machine tool and user. The system comprises parts (i) to (viii) enumerated in Embodiment 2.
a. The device collects voltage, current, wattage, power factor data from the machine tool in realtime based on the sensor measurements.
b. The device performs anonymisation of data by subtracting the mean value of the data values calculated every 60 sec from each instantaneous data value, and then dividing the resultant value by the standard deviation of data values calculated every 60 sec.
c. Further anonymisation is performed by creating random noise of normal distribution, with a mean of 0 and a standard deviation corresponding to 1/10^{th} of the standard deviation of the data values, and adding the random noise to the data values.
d. Further anonymisation is performed by expressing each subsequent value as an incremental arithmetic operation on the initial data value that was monitored by the device.
e. The anonymised data is expressed as ASCII text and communicated to the local server over a TCP socket. The local server stores the data and forwards to the remote server which, in turn, stores it in the data warehouse.

Embodiments and variations other than described herein above are feasible by persons skilled in the art and the same are within the scope and spirit of this invention.

1.-70. (canceled)

71. A system for the control, management and optimisation of industrial machines that is connectable to, or interfaceable with one or more industrial machines, comprising the following elements:
a. sensors for the collection of at least one of intrinsic and extrinsic operational parameters of one or more said industrial machines, that are interfacing with such one or more industrial machines for the generation of the operational data relating to such industrial machines;
b. a device connectable to one or more such sensors, and having the means to:
i. collect and log the data relating to one or more of at least one of the intrinsic and extrinsic operational parameters of such industrial machines;
ii. convert such data into a format suitable for comparison thereof with reference data;
iii. relay such converted data to a server,
c. a comparison device for comparison of such relayed data with reference data comprising operational intelligence further comprising at least one of historical and contemporary operating data harvested from at least one of said machines and others of the same or other species;
d. an input/output generation means for generating at least one of control inputs and signal outputs;
e. signal outputs for displaying instructions for maintenance of said machine(s) according to a preventive, predictive or other system of maintenance and for activation of a system of maintenance
f. indicators means to indicate present and oncoming maintenance-related events;
g. control input(s) for augmenting said machine(s)' productivity
h. signal outputs for the display of parametric indicators of said machine(s)' productivity;
i. control input(s) for the improvement of the operational efficiency of said machine(s);
j. signal outputs for the display of parametric indicators of the improvement of the operational efficiency of said machine(s);
k. control input(s) for optimisation of the performance of said machine(s);
l. signal outputs for the display of parametric indicators of such optimisation of machine performance;
m. control input(s) for the improvement of environmental impact(s) of said machines;
n. signal outputs for displaying parametric indicators of improvement in the environmental impact(s) of said machines; and
o. signal output(s) for activation of a system of alerts to indicate present and oncoming safety-related events;

72. The system as claimed in claim 71 where said comparison of relayed data with reference data comprises multi-variate correlation analysis, thresholding and symbolic and non-symbolic pattern matching of one or more of individual said at least one of data and patterns and sequences thereof that constitute event(s) and phenomenon(a) therein

73. The system as claimed in claim 71 where reference data is drawn from an external centralised operational data warehouse;

74. The system as claimed in claim 72 where said comparison and signal generation are being carried out in real-time.

75. The system as claimed in claim 71 wherein such relayed data is harvested from said machine(s) and is added to the store of said reference data on a periodical or continuous basis.

76. The system as claimed in claim 71 wherein said comparison device is a local or remote server.

77. The system as claimed in claim 71 wherein said comparison device comprises a central common operating data warehouse server connectable through a networked communication system such as the internet, said common operating data warehouse server serving a plurality of said manufacturing systems and devices.

78. The system as claimed in claim 77 wherein said central common operating data warehouse server services a plurality of installations comprising said machine(s) in real-time and receives said operational intelligence data from said machines in real-time.

79. The system as claimed in claim 71 wherein said extrinsic attributes may include instantaneous voltage, amperage, wattage and power factor, compressed air flow and consumable flow.

80. A method of control, management and optimisation of industrial machines comprising the following steps:
a. interfacing with such one or more industrial machines for the generation of the operational data relating to such industrial machines by means of one or more sensors
b. collecting said operational data of one or more said industrial machines by means of a device connectable to said one or more sensors
c. logging the data relating to one or more of the at least one of intrinsic and extrinsic operational parameters of such industrial machines by means of said device;
d. converting such data into a format suitable for comparison thereof with reference data by means of said device;
e. relaying such converted data to a server by means of said device,
f. comparing such relayed data by means of a comparison device with reference data comprising operational intelligence further comprising at least one of historical and contemporary operating data harvested from at least one said machines and others of the same or other species;
g. generating at least one control inputs and signal outputs by means of an input/output generation means
h. Relaying at least one of such control inputs and signal outputs to the industrial machine

81. The method as claimed in claim 80 where said comparison of relayed data with reference data stored on the server comprises multi-variate correlation analysis, thresholding and symbolic and non-symbolic pattern matching of one or more of at least one of individual said data and patterns and sequences thereof that constitute event(s) and phenomenon(a) therein

82. The method as claimed in claim 80 where reference data is drawn from an external centralised operational data warehouse;

83. The method as claimed in claim 80 where said comparison and signal generation are being carried out in real-time.

84. The method as claimed in claim 80 wherein such relayed data is harvested from said machine(s) and is added to the store of said reference data on a periodical or continuous basis.

85. The method as claimed in claim 80 wherein said comparison device is a local or remote server.

86. The method as claimed in claim 80 wherein said comparison device comprises a central common operating data warehouse server connectable through a networked communication system such as the internet, said common operating data warehouse server serving a plurality of said manufacturing systems and devices.

87. The method as claimed in claim 86 wherein said central common operating data warehouse server services a plurality of installations comprising said machine(s) in real-time and receives said operational intelligence data from said machines in real-time.

88. The method as claimed in claim 80 wherein said extrinsic attributes may include instantaneous voltage, amperage, wattage and power factor, compressed air flow and consumable flow.

89. A method of transforming of the operational data of the intrinsic and extrinsic operational attributes of one or more industrial machine(s) for use in a control, management and optimisation system thereof comprising,
a. interfacing with such one or more industrial machines for the generation of the operational data relating to such industrial machines by means of one or more sensors
b. collecting said operational data of one or more said industrial machines by means of a device connectable to said one or more sensors;
c. logging the data relating to one or more of at least one of the intrinsic and extrinsic operational parameters of such industrial machines by means of said device;
d. converting such data into a format suitable for comparison thereof with reference data by means of said device;
e. relaying such converted data to a server by means of said device,
f. comparing such relayed data by means of a comparison device with reference data comprising operational intelligence further comprising at least one of historical and contemporary operating data harvested from at least one of said machines and others of the same or other species;
g. generating at least one of control inputs and signal outputs by means of an input/output generation means
h. Relaying at least one of such control inputs and signal outputs to the industrial machine,

90. The method as claimed in claim 89, wherein the control inputs relayed to the industrial machine relate to the productivity, efficiency and optimisation of said machine(s) and the parametric indicators thereof include one or more of the following:
a. production efficiency;
b. material and machine utilisation;
c. production cycle time;
d. downtime;
e. good parts count;
f. bad parts count;
g. total parts count;
h. production time;
i. non-process production time,
j. process time,
k. consumable consumption rate, and
l. accessory usage rate,
the generation of said metrics being based on the levels of power consumption, the compressed air flow rate and the consumable flow rate and the generated responses/messages being formatted for transmission to the said centralised data warehouse server or the local or remote server.

91. The method as claimed in claim 89, wherein the control inputs relayed to the industrial machine relate to risk evaluation and reference function, and the parametric indicators thereof include one or more of the following:
a. probability of injury to a user/operator;
b. probability of damage to the surrounding environment at the workplace;
c. probability of internal damage to the said machine(s);
d. probability of damage to the workpiece(s); and
e. probability of damage to the consumables such as, for example, the toolings;
the generation of said metrics being based on the levels of power consumption, the compressed air flow rate and the consumable flow rate and the generated responses/messages being formatted for transmission to the said centralised data warehouse server or the local or remote server.

92. The method as claimed in claim 89, wherein the control inputs relayed to the industrial machine relate to health and maintenance evaluation of the said machine(s), and the parametric indicators thereof include one or more of the following:
a. time available before probable failure of the machine tool and each of the components thereof;
b. probability of imminent failure of the tool system;
c. health rating of the tool system between 0% and 100%, the former indicating probable imminent failure and the latter perfect condition thereof;
d. probable time before the next failure of machine tool consumables;
e. consumables usage rate;
f. machine tool wear rate; and
g. machine tool accessory wear rate,
the generation of said metrics being based on the levels of power consumption, the compressed air flow rate and the consumable flow rate and the generated responses/messages being formatted for transmission to the said centralised data warehouse server or the local or the remote server.

93. The method as claimed in claim 89 wherein said extrinsic attributes may include instantaneous voltage, amperage, wattage and power factor, compressed air flow and consumable flow.

94. The method as claimed in claim 89 wherein said industrial machines are legacy machines.

95. A method of processing of the operational data of one or more of at least one of the intrinsic or extrinsic operational attributes of one or more industrial machines for use in a control, management and optimisation system thereof comprising:
a. normalising said operational data for the purposes of comparison with historical data, said historical data comprising operational data derived from at least one of said machines of the same species or of other machines, and the analysis thereof;
b. selectively filtering, classifying and selecting historical data using present operational data;
c. evaluating/rating the current performance of the said machine(s) relative to historical performance;
d. normalising said operational data for carrying out comparative analysis across different species of said machine(s);
e. generating control input(s) for performance upgrading of said machine(s); and
f. anonymising said operation data of machine(s) in order to mask the identity of the specific machine and the user.

96. The method as claimed in claim 95, wherein said normalising of operational data as per step (i) comprises:
conversion of the data into a format suitable for comparison with historical data sets, comprising identification and removal of non-standard data artifacts such as peaks, identification and marking of artifacts that distinguish the present data from the historical, and normalising based on key statistical parameters such as mean and standard deviation, spatial and temporal transformations using geometrical parameters.

97. The method as claimed in claim 95, wherein said selective filtering, classifying and selecting of historical data as per step (ii) comprises identifying, filtering and classifying current(present) data such as to select suitable historical data for comparison thereof therewith; identifying suitable historical data on the basis of one or more factors selected from, but not limited to, frequency analysis, spectral analysis, motif detection analysis, symbolic and non-symbolic pattern recognition and peak detection, classifying and tagging historical data using both qualitative and quantitative means based on the criteria of the level of matching thereof with said present data sets and ranking and filtering said tagged and classified historical data sets on the basis of the suitability thereof for said comparison, and analysis.

98. The method as claimed in claim 95, wherein the evaluating/rating of the current performance of the said machine(s) relative to historical performance as per step (iii) comprises:
constructing a numerical function denoting the historical baseline performance data, convolving a plurality of such historical data using statistical mapping and averaging to create a single historical baseline data, analysing said baseline data to detect pertinent and relevant patterns that relate performance, health, risk and status attributes of the machine(s),

99. The method as claimed in claim 95, wherein said normalising of operational data as per step (iv) comprises:
normalisation of the said operational data into a format suitable for comparison across different historical data sets of different machines, including removal of non-standard data artifacts such as peaks, identification and marking of artifacts that distinguish the current (present) data from historical data and differentiating operation data based on key statistical parameters such as the mean and standard deviation, spatial and temporal transformations.

100. The method as claimed in claim 95, wherein said generating control input(s) as per step (v) comprises:
i. collecting current performance data of said machine(s);
ii. collecting/downloading said historical data for said machine(s); and
iii. comparing the data of (i) and (ii) to generate control input(s) to effect a technical upgrade of the performance of the said machine(s) to the level of the said historical data of (ii), said input(s) being one or more commands such as, but not limited to, to stop the machine operation, increase/decrease feedrate, increase/decrease spindle speed, issuing of a warning, to engage the ESTOP trigger and others.

101. The method as claimed in claim 95, wherein said anonymising of operation data as per step (vi) comprises:
anonymisation of the said operation data of the machine(s) by the removal of unique and idiosyncratic markers and other distinguishing features, if any, therein such as to substantially prevent determination, by an unrelated third party, of the specific identity of the said machine(s), the nature of the operation, the identity of the user, the geometry, material and other characteristics of the part/product being made and the nature and identity of the consumables and accessorised being used, said by one or more operations such as, but not limited to, eliminating differences between realtime data and a function-based baseline average, de-noising, phase-shifting and others.

102. The method as claimed in claim 95 wherein said extrinsic attributes may include instantaneous voltage, amperage, wattage and power factor, compressed air flow and consumable flow.

103. A device for use in a control, management and optimisation system that is connectable to, or interfaceable with one or more sensors connected to, or interfacing with one or more industrial machines, the function of said device being:
i. collecting, logging, converting and relaying the data of one or more of at least one of the intrinsic or extrinsic operational attribute(s)(parameters) of said one or more industrial machines; and
ii. converting, upgrading, modulating and analysing said data from (i) and relaying said data to a server for comparison/matching thereof with reference data,
said comparison/matching of the data from item (ii) with reference data, comprising multi-variate correlation analysis, thresholding and symbolic and non-symbolic pattern matching of one or more of at least one of individual said data or patterns and sequences thereof that constitute event(s) and phenomena therein, and generating at least one of control inputs and signal output(s) for carrying out one or more of the functions following functions:
a. signal outputs for displaying instructions for maintenance of said machine(s) according to a preventive, predictive or other system of maintenance and for activation of a system of maintenance
b. indicators means to indicate present and oncoming maintenance-related events;
c. control input(s) for augmenting said machine(s)' productivity
d. signal outputs for the display of parametric indicators of said machine(s)' productivity;
e. control input(s) for the improvement of the operational efficiency of said machine(s);
f. signal outputs for the display of parametric indicators of the improvement of the operational efficiency of said machine(s);
g. control input(s) for optimisation of the performance of said machine(s);
h. signal outputs for the display of parametric indicators of such optimisation of machine performance;
i. control input(s) for the improvement of environmental impact(s) of said machines;
j. signal outputs for displaying parametric indicators of improvement in the environmental impact(s) of said machines; and
k. signal output(s) for activation of a system of alerts to indicate present and oncoming safety-related events;
said reference data being preferably operational intelligence comprising at least one of historical and contemporary operational data harvested from at least one of said machine(s) and others of the same or other species and housed in said server or drawn from a central data warehouse, and said comparison and signal generation being carried out in real-time or otherwise.

104. The device for use in a control, management and optimisation system, as claimed in the preceding claim 103, said device being unitary and portable.

105. The device for use in a control, management and optimisation system, as claimed in the preceding claim 103 wherein said extrinsic attributes may include instantaneous voltage, amperage, wattage and power factor, compressed air flow and consumable flow.

106. The device for use in a control, management and optimisation system, as claimed in the preceding claim 103 wherein further said operational intelligence data harvested from said machine(s) or others of the same or other species is added to the store of said reference data on a periodical or continuous basis.

107. The device for use in a control, management and optimisation system as claimed in the preceding claim 106 wherein said operational intelligence data is housed in a said server and the said comparison and signal generation is carried out therein.

108. The device for use in a control, management and optimisation system, as claimed in the preceding claim 107 wherein said device is connectable to said server through a networked communication system such as the internet, said server serving a plurality of said devices/systems.

109. The device for use in a control, management and optimisation system, as claimed in the preceding claim 103 wherein said device is connectable to a local server.

110. The device for use in a control, management and optimisation system, as claimed in the preceding claim 109 wherein said device and said local server are a single unitary whole.
